(19) United States
(12) Patent Application Publication
(10) Pub. No.: US 2024/0027995 A1
(43) Pub. Date: Jan. 25, 2024

(54) PROCESS FOR MANUFACTURING CUSTOMIZED BICYLE HANDLE GRIP AND SYSTEM THEREOF

(71) Applicant: TIEN HSIN INDUSTRIES CO., LTD., Taichung City (TW)

(72) Inventor: MENG-HUA CHIANG, Taichung City (TW)

(73) Assignee: TIEN HSIN INDUSTRIES CO., LTD., Taichung City (TW)

(21) Appl. No.: 17/869,981

(22) Filed: Jul. 21, 2022

(51) Int. Cl. G05B 19/4099; G06T 19/20; B33Y 50/00; B33Y 80/00

(52) U.S. Cl. CPC G05B 19/4099; G06T 19/20; B33Y 50/00; B33Y 80/00; G06T 2219/2021; G05B 2219/35134; G05B 2219/49023

(57) ABSTRACT

A process for manufacturing a customized bicycle handle grip includes obtaining a hand shape database including a hand shape information of users. The hand shape information of each user includes a dimensional parameter including a measured value. The measured values in the hand shape database are divided into dimensional intervals, wherein a handle grip forming parameter is designed for each dimensional interval. After that, a hand shape information of a client is obtained to be compared with the hand shape information in the hand shape database to be classified into one of the dimensional intervals. The handle grip forming parameter of the one of the dimensional intervals is obtained for generating a 3D-computer-graphics of the customized bicycle handle grip based on the handle grip forming parameter. Then, define the hand shape information of the client as a restricting region and optimize the 3D-computer-graphics to obtain an optimized 3D-computer-graphics for 3D printing.

### BACKGROUND OF THE INVENTION

### Technical Field

The present disclosure relates generally to a process for manufacturing a bicycle handle grip, and more particularly to a process and a system for manufacturing a customized bicycle handle grip.

### Description of Related Art

Nowadays, bicycle handle grips are mass-produced. For convenience, a design of the handle grip, such as the shape and the configuration of the handle grip, is uniform and not individualized. Since the shape and the configuration of the handle grip are fixed, the handle grips that are mass-produced usually cannot fulfill the individual requirement of each person. Thus, when a user holds the handle grips, which are mass-produced and adopt the uniform design, for a long time, the user may feel sore, the blood circulation in the hands becomes poor, or the handgrip strength of the hand turns out unbalanced.

### BRIEF SUMMARY OF THE INVENTION

In view of the above, the primary objective of the present disclosure is to provide a process for manufacturing a customized bicycle handle grip. By utilizing a database, after a hand of a client is measured to obtain a hand shape information of the client, an optimized bicycle handle grip could be rapidly 3D printed for the purchase to try, buy, and use, thereby solving a problem that a shape of the bicycle handle grip is not conform to the individual requirements of each person.

The present disclosure provides a process for manufacturing a customized bicycle handle grip, including the following steps:
Obtain a hand shape database, wherein the hand shape database includes hand shape information of a plurality of users. The hand shape information of each of the plurality of users includes at least one dimensional parameter, and the at least one dimensional parameter at least includes a measured value. The measured values in the hand shape database are divided into a plurality of dimensional intervals.
Design a handle grip forming parameter for each of the dimensional intervals.
Obtain a hand shape information of a client, wherein the hand shape information of the client is compared with the hand shape information stored in the hand shape database to be classified into one of the dimensional intervals. The handle grip forming parameter of the one of the dimensional intervals is obtained for generating a 3D computer graphics of the customized bicycle handle grip based on the handle grip forming parameter.
Optimize the 3D computer graphics of the customized bicycle handle grip by topology optimization to obtain an optimized 3D computer graphics for 3D printing.

The present disclosure further provides a process for manufacturing a customized bicycle handle grip, including the following steps:
Establish a hand shape database and a handle grip forming parameter database at a host end, wherein the hand shape database includes hand shape information of a plurality of users. The hand shape information of each of the plurality of users includes at least one dimensional parameter, and the at least one dimensional parameter at least includes a measured value. The measured values in the hand shape database are divided into a plurality of dimensional intervals. The handle grip forming parameter database includes a plurality of handle grip forming parameters, wherein each of the plurality of dimensional intervals corresponds to at least one of the plurality of handle grip forming parameters.
Obtain a hand shape information of a client by a terminal end, wherein the hand shape information of the client is transmitted to the host end from the terminal end. The host end compares the hand shape information of the client with the hand shape information stored in the hand shape database to classify the hand shape information of the client into one of the dimensional intervals and obtains at least one of the plurality of handle grip forming parameters that corresponds to the one of the dimensional intervals to generate a 3D computer graphics of the customized bicycle handle grip based on the at least one of the plurality of handle grip forming parameters, which is obtained. The host end defines the hand shape information of the client as a restricting region and optimizes the 3D computer graphics by topology optimization to obtain an optimized 3D computer graphics of the customized bicycle handle grip.
Send the optimized 3D computer graphics to a 3D printer from the host end, wherein the 3D printer prints out a sample of the customized bicycle handle grip according to the optimized 3D computer graphics.

The present disclosure further provides a system for manufacturing a customized bicycle handle grip, including a host end and a terminal end. The host end has a hand shape database and a handle grip forming parameter database, wherein the hand shape database includes hand shape information of a plurality of users. The hand shape information of each of the plurality of users includes at least one dimensional parameter, and the at least one dimensional parameter at least includes a measured value. The measured values in the hand shape database are divided into a plurality of dimensional intervals. The handle grip forming parameter database includes a plurality of handle grip forming parameters, and each of the dimensional intervals corresponds to one or more of the handle grip forming parameters. The terminal end has a hand measuring interface and is coupled to the host end via a signal connection, wherein the hand measuring interface is adapted to obtain a hand shape information of a client, and the hand shape information of the client is transmitted to the host end from the terminal end. The host end compares the hand shape information of the client, which is received by the host end, with the hand shape information in the hand shape database to obtain the handle grip forming parameters corresponding to the dimensional interval, which the hand shape information of the client is classified into; the host end generates a 3D computer graphics of the customized bicycle handle grip according to the handle grip forming parameters that are obtained. The host end defines the hand shape information of the client as a restricting region and optimizes the 3D computer graphics of the customized bicycle handle grip by topology optimization to generate an optimized 3D computer graphics for being 3D printed.

With such design, the hand shape information of the plurality of users includes different dimensional parameters, wherein the measured values of each of the different dimensional parameters are divided into several dimensional intervals. Each of the dimensional intervals corresponds to one or more of the handle grip forming parameters, wherein the handle grip forming parameters could define the shapes of different parts of the customized bicycle handle grip. In the process or the system, after the hand shape information of the client is obtained. The comparison between the hand shape information of the client and the hand shape information in the database could be conducted immediately and quickly to generate the 3D computer graphics and the optimized 3D computer graphics of the customized bicycle handle grip for sending to the 3D printer. Thus, the sample of the customized bicycle handle grip, which is customized and individualized for the client, could be printed. After that, the client could try the printed customized bicycle handle grip, so that the printed sample could be further modified based on the matching condition between the hand of the client and the printed sample of the customized bicycle handle grip, thereby solving the problem of soreness due to the poor blood circulation and unbalanced handgrip strength due to fatigue after holding the hand-grip that is not customized.

### BRIEF DESCRIPTION OF THE SEVERAL VIEWS OF THE DRAWINGS

The present disclosure will be best understood by referring to the following detailed description of some illustrative embodiments in conjunction with the accompanying drawings, in which

FIG. 1 is a flowchart of the manufacturing process of the customized handle grip of an embodiment according to the present disclosure;

FIG. 2 is a block diagram of the system for conducting the manufacturing process of the customized handle grip of the embodiment according to the present disclosure; and

FIG. 3 is a flowchart of the manufacturing process of the customized handle grip of another embodiment according to the present disclosure.

### DETAILED DESCRIPTION OF THE INVENTION

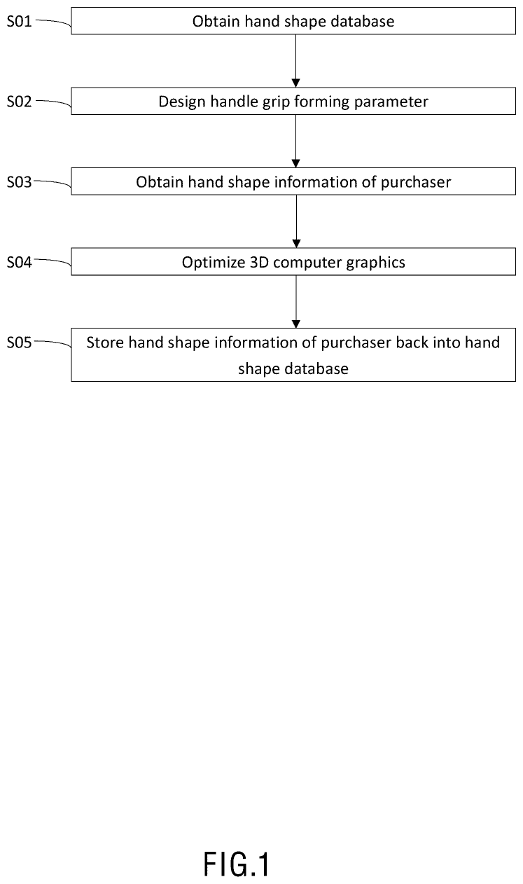

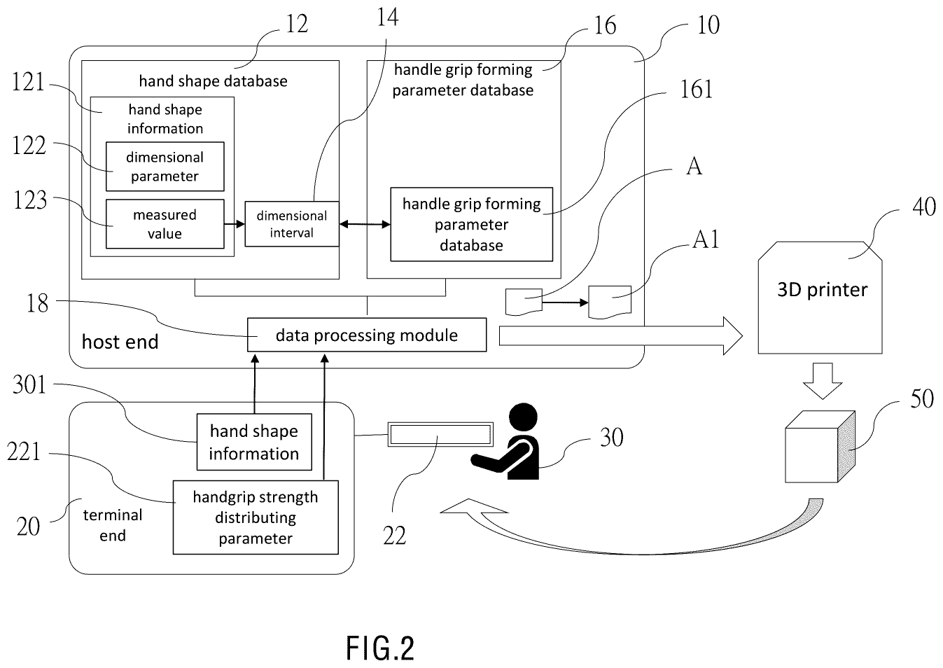

As illustrated in FIG. 1, a process for manufacturing a customized bicycle handle grip of an embodiment according to the present disclosure is shown, wherein the process is conducted among a host end 10, a terminal end 20, and a client 30, as shown in FIG. 2. In the current embodiment, the host end 10 is a server in a manufacturing center of a manufacturer, and the terminal end 20 is a computer in a retail store of customized bicycle handle grips for interacting with the client. The process for manufacturing the customized bicycle handle grip includes the following steps.

Step S01: Obtain a hand shape database 12 that includes hand shape information 121 of a plurality of users, wherein the hand shape information 121 includes at least one dimensional parameter 122, and the dimensional parameter 122 at least includes a measured value 123. The measured values 123 of each of the at least one dimensional parameter 122 in the hand shape database 12 are divided into a plurality of dimensional intervals 14 that are equal or defined based on a predetermined distribution percentage. In other embodiments, the dimensional intervals 14 could be defined by clustering or other rules on required demand.

Step S02: Design one or more handle grip forming parameters 161 for each of the dimensional intervals 14. In the current embodiment, the parameters 161 for forming a handle grip corresponding to each of the dimensional intervals 14 is based on the hand shape information 121 of multiple users and specification information of customized handle grips used by the multiple users. In other embodiment, handle grip forming parameters 161 corresponding to each of the dimensional intervals 14 are captured from the hand shape information 121 of the plurality of users and customized handle grip shape information corresponding to the hand shape information 121 of the plurality of users. The measured values 123 are divided into different dimensional intervals 14 by clustering. The customized handle grip shape information corresponding to the measured values 123 in the same dimensional interval 14 is processed to obtain a mean value or a median value of the customized handle grip shape information, thereby taking the mean value or a median value of the handle grip shape information as the handle grip forming parameters 161 corresponding to the dimensional interval 14.

Step S03: Obtain a hand shape information 301 of the client 30 and compare the hand shape information 301 of the client 30 with the plurality of hand shape information 121 stored in the hand shape database 12 to classify the hand shape information 301 of the client 30 into one of the dimensional intervals 14 and obtain the handle grip forming parameters 161 of corresponding one of the dimensional intervals 14. Then, create a 3D computer graphics A of the customized bicycle handle grip based on the handle grip forming parameters 161. More specifically, based on the at least one dimensional parameter 122 of the hand shape information 121 in the hand shape database 12, the same dimensional parameter of the client 30 is measured to obtain the hand shape information 301 of the client 30. Measured values of the hand shape information 301 of the client 30 are compared with the hand shape information 121 in the hand shape database 12 to classify each of the measured values of the hand shape information 301 of the client 30 into one of the dimensional intervals 14, thereby obtaining the handle grip forming parameters 161 of each portion of the customized bicycle handle grip and creating the 3D computer graphics A of the customized bicycle handle grip according to the handle grip forming parameters 161 that are obtained.

Step S04: Optimize the 3D computer graphics A by topology optimization to obtain optimized 3D computer graphics A1. When the 3D computer graphics A is optimized by the topology optimization, a hand mold is simulated based on the hand shape information 301 of the client 30 and is defined as a restricting region, thereby optimizing the 3D computer graphics A of the customized bicycle handle grip. More specifically, After that, the optimized 3D computer graphics A1 could be inputted into a 3D printer 40 to print a sample 50 of the customized bicycle handle grip that is customized.

Step S05: Store the hand shape information 301 of the client 30 to the hand shape database 12 into the hand shape database 12 during the comparison between the hand shape information 301 of the client 30 and the hand shape information 121 in the hand shape database 12.

In the current embodiment, the dimensional parameter 122 includes, but is not limited to, a finger length, a palm width, a purlicue angle, a palm thickness, and a relative position between the finger bones. The finger length could include measured values of lengths of fingers, such as a thumb, an index finger, a middle finger, a ring finger, and a little finger. The relative position between the finger bones includes a distance between a distal end of a phalange and a distal end of a metacarpal, a distance between a distal end of a metacarpal of thumb and a distal end of any one of the phalanges of the other four fingers, or a distance between a distal end of each metacarpal and a particular site of the carpal bones.

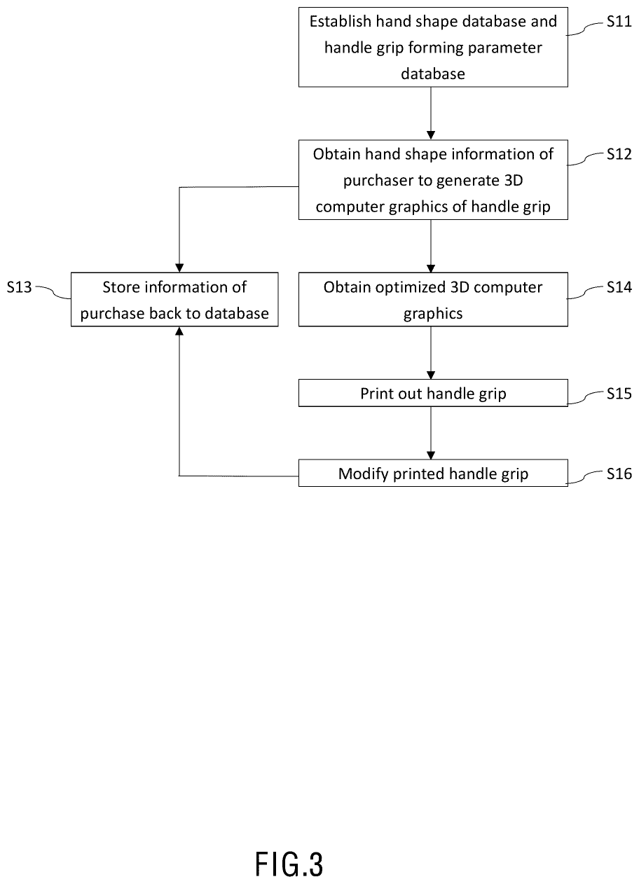

As illustrated in FIG. 3, a process for manufacturing a customized bicycle handle grip of another embodiment according to the present disclosure is shown, which particularly discloses the process that is conducted among a host end 10, a terminal end 20, and a client 30, wherein the process for manufacturing the customized bicycle handle grip includes the following steps.

Step S11: Establish a hand shape database 12 and a handle grip forming parameter database 16 at the host end 10. The hand shape database 12 includes hand shape information 121 of a plurality of users, wherein the hand shape information 121 of each of the users includes at least one dimensional parameter 122, and the dimensional parameter 122 at least includes a measured value 123. The measured values 123 in the hand shape database 12 are divided into a plurality of dimensional intervals 14. The handle grip forming parameter database 16 includes a plurality of handle grip forming parameters 161.

In the current embodiment, raw data of the handle grip forming parameters 161 is obtained by measuring a customized handle grip of each of the plurality of users or capturing dimensional information from a 3D computer graphics of the customized handle grips, thereby allowing each of the customized handle grips to correspond to one of the intervals of at least one dimensional parameter 122 to obtain handle grip shape information. In other embodiments, the handle grip shape information could be the handle grip forming parameters 161 of each of the customized handle grips corresponding to one of the dimensional intervals 14. Alternatively, in other embodiments, the raw data of the handle grip forming parameters 161 could be captured from an ergonomic database and default values of the handle grip forming parameters. More specifically, the measured values 123 are divided into different dimensional intervals 14 by clustering. The customized handle grip shape information corresponding to the measured values 123 in the same dimensional interval 14 is processed to obtain a mean value or a median value of the customized handle grip shape information, thereby taking the mean value or a median value of the handle grip shape information as the handle grip forming parameters 161 corresponding to the dimensional interval 14.

Step S12: Obtain the hand shape information 301 of a client 30 to create a 3D computer graphics A of the customized bicycle handle grip. The hand shape information 301 of a client 30 is obtained by a terminal end 20. In the current embodiment, the terminal end 20 is disposed with a hand measuring interface 22, so that a hand of the client 30 could be measured to obtain the hand shape information 301 in a retail store of customized bicycle handle grips, and then the hand shape information 301 of the client 30 could be entered through the hand measuring interface 22 of the terminal end 20. In other embodiment, the hand measuring interface 22 of the terminal end 20 includes a camera, so that the camera could capture the hand of the client 30 to measure the hand shape information 301 of the client 30 by image recognition to enter the terminal end 20.

Then the hand shape information 301 of the client 30 could be transmitted to the host end 10 from the terminal end 20, wherein the host end 10 is disposed with a data processing module 18. The data processing module 18 is connected to the hand shape database 12 and the handle grip forming parameter database 16 and is adapted to receive and compare the hand shape information 301 of the client 30 with the hand shape information 121 stored in the hand shape database 12 to determine the measured value of each of the dimensional parameters of the client 30 is classified into which one of the dimensional intervals 14, thereby obtaining the handle grip forming parameters 161 corresponding to each portion of the hand of the client 30 to create the 3D computer graphics A of the customized bicycle handle grip.

Step S13: Store information of the client 30 back to the hand shape database 12. The hand shape information 301 of the client 30 is stored in the hand shape database 12 during the comparison between the hand shape information 301 of the client 30 and the hand shape information 121 of the hand shape database 12.

Step S14: Optimize the 3D computer graphics A to create an optimized 3D computer graphics A1. The data processing module 18 of the host end 10 defines the hand shape information 301 of the client 30 as a restricting region and optimizes the 3D computer graphics A of the customized bicycle handle grip by topology optimization to create the optimized 3D computer graphics A1.

Step S15: Print the sample 50 of the customized bicycle handle grip. The optimized 3D computer graphics A1 is transmitted to a 3D printer 40 from the host end 10, and the 3D printer 40 prints the sample 50 of the customized bicycle handle grip out according to the optimized 3D computer graphics A1.

Step S16: Modify the sample 50 of the customized bicycle handle grip. The manufacturer sends the sample 50 that is printed to the retail store where the client 30 is located for the client 30 to try the sample 50 of the customized bicycle handle grip. After the sample 50 is tried by the client 30, the sample 50 could be modified based on a condition of a client to hold the sample to be more fit to the hand of the client 30. After the sample 50 of the customized bicycle handle grip is modified, the customized bicycle handle grip shape information of the sample 50 that is modified is optionally stored into the customized bicycle handle grip forming parameter database 16 at the host end 10, as the step S13.

In the step S16, the hand measuring interface 22 of the terminal end 20 could include a handgrip strength sensor that includes a plurality of pressure sensors. By using the plurality of pressure sensors corresponding to different portions of the hand, when the client 30 holds the handle grip, the handgrip strength sensor could measure handgrip strength distributing parameters 221 of the client 30. After an operator in the retailer obtains the sample 50 of the customized bicycle handle grip, the operator could modify the sample 50 of the customized bicycle handle grip according to the handgrip strength distributing parameters 221 of the client 30 or add a cushion on the sample 50 of the customized bicycle handle grip. A handle grip shape information and a location on the cushion of the sample 50 that is modified according to the handgrip strength distributing parameters 221 is optionally uploaded to the handle grip forming parameter database 16 of the host end 10. In an embodiment, when the handle grip shape information of the sample 50 that is modified is stored into the handle grip forming parameter database 16 at the host end 10, the handgrip strength distributing parameter 221 of the client 30 during holding the customized bicycle handle grip that is modified is stored back to the hand shape database 12 of the host end 10.

The process for manufacturing the customized bicycle handle grip of the embodiments of the present disclosure is performed by a system for manufacturing the customized bicycle handle grip, wherein the system includes a host end 10 and a terminal end 20. The host end 10 has the hand shape database 12, the handle grip forming parameter database 16, and the data processing module 18 as mentioned above. The hand shape database 12 includes hand shape information 121 of a plurality of users, wherein the hand shape information 121 includes at least one dimensional parameter 122, and the dimensional parameter 122 at least includes a measured value 123. The measured values 123 in the hand shape database 12 are divided into a plurality of dimensional intervals 14 by clustering. The handle grip forming parameter database 16 includes a plurality of handle grip forming parameters 161, and each of the dimensional intervals 14 corresponds to one or more of the handle grip forming parameters 161.

The terminal end 20 is wired or wirelessly connected to the data processing module 18 of the host end 10. The terminal end 20 has the hand measuring interface 22, which is adapted to obtain the hand shape information 301 of the client 30. The hand measuring interface 22 could be manually inputted the hand shape information 301 of the client 30 to the terminal end 20. Alternatively, the hand measuring interface 22 could capture an image of a hand of the client 30 via the camera of the hand measuring interface 22 to measure the hand shape information 301 of the client 30 by image recognition to enter the terminal end 20. The hand measuring interface 22 of the terminal end 20 could further include a handgrip strength sensor that includes a plurality of pressure sensors corresponding to different portions of the hand. The handgrip strength sensor is provided to sense the handgrip strength distributing parameter 221 of the client 30 when the client 30 holds something.

After the hand shape information 121 is obtained by the terminal end 20, the hand shape information 121 is transmitted to the host end 10. The data processing module 18 of the host end 10 compares the hand shape information 301, which is received by the host end 10, with the hand shape information 121 in the hand shape database 12 to obtain the handle grip forming parameters 161 corresponding to the dimensional interval 14, which the hand shape information 301 of the client 30 is classified into. After that, the data processing module 18 of the host end 10 generates a 3D computer graphics A of the customized bicycle handle grip according to the handle grip forming parameters 161 that are obtained. The host end 10 defines the hand shape information 301 of the client 30 as a restricting region and optimizes the 3D computer graphics A of the customized bicycle handle grip by topology optimization to generate the optimized 3D computer graphics A1 for being 3D printed to obtain a sample 50 of the customized bicycle handle grip.

By utilizing the system to perform the process for manufacturing the customized bicycle handle grip of the present disclosure, after the hand shape information 301 of the client 30 is obtained, the system could rapidly generate the 3D computer graphics A of the customized bicycle handle grip and the optimized 3D computer graphics A1 according to the handle grip shape information of known customized handle grips of other users or the ergonomic database related to the bicycle handle grip. The sample 50 of the customized bicycle is printed by the 3D printer 40 prints according to the optimized 3D computer graphics A1 and is sent to the retail store for further modification on a required demand, thereby providing the client 30 a customized and individualized bicycle handle grip in a fast and optimized manner, wherein the customized bicycle handle grip could prevent the rider from the soreness due to the poor blood circulation and the unbalanced handgrip strength due to fatigue. In another embodiment, the sample 50 that is printed by the 3D printer 40 could be sold to the client 30 without further modification.

It must be pointed out that the embodiment described above is only a preferred embodiment of the present disclosure. All equivalent systems and methods which employ the concepts disclosed in this specification and the appended claims should fall within the scope of the present disclosure.

What is claimed is:

1. A process for manufacturing a customized bicycle handle grip, comprising:
obtaining a hand shape database, wherein the hand shape database comprises a hand shape information of a plurality of users; the hand shape information of each of the plurality of users comprises at least one dimensional parameter, and the at least one dimensional parameter at least comprises a measured value; the measured values in the hand shape database are divided into a plurality of dimensional intervals;
designing a handle grip forming parameter for each of the dimensional intervals; and
obtaining a hand shape information of a client, wherein the hand shape information of the client is compared with the hand shape information stored in the hand shape database to be classified into one of the dimensional intervals; the handle grip forming parameter of the one of the dimensional intervals is obtained for generating a 3D computer graphics of the customized bicycle handle grip based on the handle grip forming parameter;
optimizing the 3D computer graphics of the customized bicycle handle grip to obtain an optimized 3D computer graphics for 3D printing by topology optimization.

2. The process as claimed in claim 1, wherein the at least one dimensional parameter comprises a finger length, a palm width, a purlicue angle, a palm thickness, or a relative position between finger bones; the finger length comprises a plurality of measured values, and the relative position between the finger bones comprises a plurality of measured values.

3. The process as claimed in claim 1, wherein the hand shape information of the client is stored in the hand shape database during the comparison between the hand shape information of the client and the hand shape information stored in the hand shape database.

4. The process as claimed in claim 1, wherein during the optimization, the hand shape information of the client is defined as a restricting region.

5. A process for manufacturing a customized bicycle handle grip, comprising:
establishing a hand shape database and a handle grip forming parameter database at a host end, wherein the hand shape database comprises a hand shape information of a plurality of users; the hand shape information of each of the plurality of users comprises at least one dimensional parameter, and the at least one dimensional parameter at least comprises a measured value; the measured values in the hand shape database are divided into a plurality of dimensional intervals; the handle grip forming parameter database comprises a plurality of handle grip forming parameters, wherein each of the plurality of dimensional intervals corresponds to at least one of the plurality of handle grip forming parameters;
obtaining a hand shape information of a client by a terminal end, wherein the hand shape information of the client is transmitted to the host end from the terminal end; the host end compares the hand shape information of the client with the hand shape information stored in the hand shape database to classify the hand shape information of the client into one of the dimensional intervals and obtains at least one of the plurality of handle grip forming parameters that corresponds to the one of the dimensional intervals to generate a 3D computer graphics of the customized bicycle handle grip based on the at least one of the plurality of handle grip forming parameters; the host end optimizes the 3D computer graphics by topology optimization to obtain an optimized 3D computer graphics for 3D printing; and
sending the optimized 3D computer graphics to a 3D printer from the host end, wherein the 3D printer prints out a sample according to the optimized 3D computer graphics.

6. The process as claimed in claim 5, wherein the at least one dimensional parameter comprises a finger length, a palm width, a purlicue angle, a palm thickness, or a relative position between finger bones; the length of the finger comprises a plurality of measured values, and the relative position between the finger bones comprises a plurality of measured values.

7. The process as claimed in claim 5, wherein the terminal end obtain a handgrip strength distributing parameter of the client.

8. The process as claimed in claim 7, wherein after the sample is obtained, the sample is modified based on a condition of the client holding the sample or the handgrip strength distributing parameter.

9. The process as claimed in claim 8, wherein after the handle grip shape information of the handle grip that is modified, a modified handle grip shape information is generated and is stored into the handle grip forming parameter database of the host end.

10. The process as claimed in claim 7, wherein the handgrip strength distributing parameter of the client is stored into the hand shape database of the host end.

11. The process as claimed in claim 5, wherein the hand shape information of the client is stored back to the hand shape database of the host end during the comparison between the hand shape information of the client and the hand shape information stored in the hand shape database.

12. The process as claimed in claim 5, wherein during the optimization, the hand shape information of the client is defined as a restricting region.

13. A system for manufacturing a customized bicycle handle grip, comprising
a host end having a hand shape database and a handle grip forming parameter database, wherein the hand shape database comprises hand shape information of a plurality of users; the hand shape information of each of the plurality of users comprises at least one dimensional parameter, and the at least one dimensional parameter at least comprises a measured value; the measured values in the hand shape database are divided into a plurality of dimensional intervals; the handle grip forming parameter database comprises a plurality of handle grip forming parameters, and each of the dimensional intervals corresponds to one or more of the handle grip forming parameters;
a terminal end having a hand measuring interface and coupled to the host end via a signal connection, wherein the hand measuring interface is adapted to obtain a hand shape information of a client, and the hand shape information of the client is transmitted to the host end from the terminal end; the host end compares the hand shape information of the client, which is received by the host end, with the hand shape information in the hand shape database to obtain the handle grip forming parameters corresponding to the dimensional interval, which the hand shape information of the client is classified into; the host end generates a 3D computer graphics of the customized bicycle handle grip according to the handle grip forming parameters; the host end optimizes the 3D computer graphics of the customized bicycle handle grip by topology optimization to generate an optimized 3D computer graphics for being 3D printed.

14. The system as claimed in claim 13, wherein the hand measuring interface comprises a handgrip strength sensor that comprises a plurality of pressure sensors corresponding to different portions of a hand.

15. The system as claimed in claim 13, wherein the at least one dimensional parameter comprises a finger length, a palm width, a purlicue angle, a palm thickness, or a relative position between finger bones; the finger length comprises a plurality of measured values, and the relative position between the finger bones comprises a plurality of measured values.

16. The process as claimed in claim 13, wherein when the host end optimizes the 3D computer graphics, the hand shape information of the client is defined as a restricting region.
